(19) United States
(12) Patent Application Publication
(10) Pub. No.: US 2013/0065433 A1
(43) Pub. Date: Mar. 14, 2013

(54) COAXIAL CABLE CONNECTOR WITH RADIO FREQUENCY INTERFERENCE AND GROUNDING SHIELD

(71) Applicant: Donald Andrew Burris, Peoria, AZ (US)

(72) Inventor: Donald Andrew Burris, Peoria, AZ (US)

(21) Appl. No.: 13/605,481

(22) Filed: Sep. 6, 2012

Related U.S. Application Data
(60) Provisional application No. 61/534,600, filed on Sep. 14, 2011.

(51) Int. Cl. H01R 9/05

(52) U.S. Cl. 439/578

(57) ABSTRACT

A radio frequency interference (RFI) and grounding shield for a coaxial cable connector is disclosed. The shield comprises a circular inner segment and at least one arcuately shaped pre-formed cantilevered annular beam attached to the circular inner segment by a joining segment. The at least one pre-formed cantilevered annular beam extends angularly from a plane of the circular inner segment. The at least one pre-formed cantilevered annular beam applies a spring-force to a surface of the surface of a component of the coaxial cable connector establishing an electrically conductive path between the components. The at least one pre-formed cantilevered annular beam comprises an outer surface with a knife-like edge that provides a wiping action of surface oxides on component surfaces of the coaxial cable connector and allows for unrestricted movement when the coaxial cable connector is attached to an equipment connection port of an appliance.

### RELATED APPLICATIONS

This application claims the benefit of priority under 35 U.S.C. §119 of U.S. Provisional Application Ser. No. 61/534,600 filed on Sep. 14, 2011, the content of which is relied upon and incorporated herein by reference in its entirety.

### BACKGROUND

1. Field of the Disclosure

The disclosure relates generally to coaxial cable connectors, and particularly to coaxial cable connectors having a flexible, resilient shield which provides radio frequency interference (RFI) and grounding shielding independent of the tightness of the coaxial cable connector to an appliance equipment connection port, and without restricting the movement of the coupler of the coaxial cable connector when being attached to the appliance equipment connection.

2. Technical Background

Coaxial cable connectors, such as type F connectors, are used to attach coaxial cable to another object or appliance, e.g., a television set, DVD player, modem or other electronic communication device having a terminal adapted to engage the connector. The terminal of the appliance includes an inner conductor and a surrounding outer conductor.

Coaxial cable includes a center conductor for transmitting a signal. The center conductor is surrounded by a dielectric material, and the dielectric material is surrounded by an outer conductor; this outer conductor may be in the form of a conductive foil and/or braided sheath. The outer conductor is typically maintained at ground potential to shield the signal transmitted by the center conductor from stray noise, and to maintain continuous desired impedance over the signal path. The outer conductor is usually surrounded by a plastic cable jacket that electrically insulates, and mechanically protects, the outer conductor. Prior to installing a coaxial connector onto an end of the coaxial cable, the end of the coaxial cable is typically prepared by stripping off the end portion of the jacket to expose the end portion of the outer conductor. Similarly, it is common to strip off a portion of the dielectric to expose the end portion of the center conductor.

Coaxial cable connectors of the type known in the trade as “F connectors” often include a tubular post designed to slide over the dielectric material, and under the outer conductor of the coaxial cable, at the prepared end of the coaxial cable. If the outer conductor of the cable includes a braided sheath, then the exposed braided sheath is usually folded back over the cable jacket. The cable jacket and folded-back outer conductor extend generally around the outside of the tubular post and are typically received in an outer body of the connector; this outer body of the connector is often fixedly secured to the tubular post. A coupler is typically rotatably secured around the tubular post and includes an internally-threaded region for engaging external threads formed on the outer conductor of the appliance terminal.

When connecting the end of a coaxial cable to a terminal of a television set, equipment box, or other appliance, it is important to achieve a reliable electrical connection between the outer conductor of the coaxial cable and the outer conductor of the appliance terminal. Typically, this goal is usually achieved by ensuring that the coupler of the connector is fully tightened over the connection port of the appliance. When fully tightened, the head of the tubular post of the connector directly engages the edge of the outer conductor of the appliance port, thereby making a direct electrical ground connection between the outer conductor of the appliance port and the tubular post; in turn, the tubular post is engaged with the outer conductor of the coaxial cable.

With the increased use of self-install kits provided to home owners by some CATV system operators has come a rise in customer complaints due to poor picture quality in video systems and/or poor data performance in computer/internet systems. Additionally, CATV system operators have found upstream data problems induced by entrance of unwanted RF signals into their systems. Complaints of this nature result in CATV system operators having to send a technician to address the issue. Often times it is reported by the technician that the cause of the problem is due to a loose F connector fitting, sometimes as a result of inadequate installation of the self-install kit by the homeowner. An improperly installed or loose connector may result in poor signal transfer because there are discontinuities along the electrical path between the devices, resulting in ingress of undesired radio frequency (“RF”) signals where RF energy from an external source or sources may enter the connector/cable arrangement causing a signal to noise ratio problem resulting in an unacceptable picture or data performance. Many of the current state of the art F connectors rely on intimate contact between the F male connector interface and the F female connector interface. If, for some reason, the connector interfaces are allowed to pull apart from each other, such as in the case of a loose F male coupler, an interface “gap” may result. If not otherwise protected this gap can be a point of RF ingress as previously described.

As mentioned above, the coupler is rotatably secured about the head of the tubular post. The head of the tubular post usually includes an enlarged shoulder, and the coupler typically includes an inwardly-directed flange for extending over and around the shoulder of the tubular post. In order not to interfere with free rotation of the coupler, manufacturers of such F-style connectors routinely make the outer diameter of the shoulder (at the head of the tubular post) of smaller dimension than the inner diameter of the central bore of the coupler. Likewise, manufacturers routinely make the inner diameter of the inwardly-directed flange of the coupler of larger dimension than the outer diameter of the non-shoulder portion of the tubular post, again to avoid interference with rotation of the coupler relative to the tubular post. In a loose connection system, wherein the coupler of the coaxial connector is not drawn tightly to the appliance port connector, an alternate ground path may fortuitously result from contact between the coupler and the tubular post, particularly if the coupler is not centered over, and axially aligned with, the tubular post. However, this alternate ground path is not stable, and can be disrupted as a result of vibrations, movement of the appliance, movement of the cable, or the like.

Alternatively, there are some cases in which such an alternate ground path is provided by fortuitous contact between the coupler and the outer body of the coaxial connector, provided that the outer body is formed from conductive material. This alternate ground path is similarly unstable, and may be interrupted by relative movement between the appliance and the cable, or by vibrations. Moreover, this alternate ground path does not exist at all if the outer body of the coaxial connector is constructed of non-conductive material. Such unstable ground paths can give rise to intermittent failures that are costly and time-consuming to diagnose.

### SUMMARY OF THE DETAILED DESCRIPTION

One embodiment includes a radio frequency interference (RFI) and grounding shield for a coaxial cable connector. The shield comprises an inner segment and at least one arcuately shaped pre-formed cantilevered annular beam attached to the inner segment by a joining segment. The at least one pre-formed cantilevered annular beam extends angularly from a plane of the circular inner segment. The at least one pre-formed cantilevered annular beam applies a spring-force to a surface of one of the coupler and body of the coaxial cable connector establishing an electrically conductive path between the components. The at least one pre-formed cantilevered annular beam comprises an outer surface with a knife-like edge that provides a wiping action of surface oxides on the coupler surface of the coaxial cable connector and allows for unrestricted movement when the coaxial cable connector is attached to an appliance equipment connection port of an appliance.

A further embodiment includes a coaxial cable connector comprising a tubular post, a coupler, a body and a shield. The body and the post are in intimate electrical and mechanical communication by means of a press-fit between corresponding conductive surfaces. The shield provides an electrically conductive path between the coupler and the body providing a shield against RF ingress. The coaxial cable connector couples a prepared end of a coaxial cable to a threaded female equipment port. The tubular post has a first end adapted to be inserted into the prepared end of the coaxial cable between the dielectric material and the outer conductor thereof. The coupler is rotatably attached over a second end of the tubular post. The coaxial cable connector includes a central bore, at least a portion of which is threaded for engaging the female equipment port. The body extends about the first end of the tubular post for receiving the outer conductor, and preferably the cable jacket, of the coaxial cable.

A resilient, electrically-conductive shield is disposed about the body between the body and the coupler. This shield engages both the body and the coupler for providing an electrically-conductive path therebetween, but without noticeably restricting rotation of the coupler relative to the tubular post. The shield may be generally circular and includes a plurality of pre-formed flexible annular cantilevered beams. The tubular post comprises an enlarged shoulder extending inside the coupler with a first rearward facing annular shoulder and a stepped diameter leading to a second rearward facing annular shoulder. The coupler comprises a forward facing annular surface, a through-bore and a rearward facing annular surface. The body at least partially comprises a face, a through bore and an external annular surface. The shield is disposed between the rearward facing annular surface of the coupler and the body. The pre-formed flexible cantilevered annular beam(s) of the shield are at least partially disposed against the rearward facing annular surface of the coupler. The shield is resilient relative to the longitudinal axis of the connector and maintains an arcuately increased surface of sliding electrical contact between shield and the rearward facing annular surface of the coupler. At the same time the shield is attached to the body providing electrical and mechanical communication between the coupler, and the body while allowing smooth and easy rotation of the coupler. The coaxial cable connector may also include a sealing ring seated within the coupler for rotatably engaging the body member to form a seal therebetween.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross sectional view of an embodiment of a type of a coaxial connector with a shield dispose therein;

FIG. 1A is a detail section of a portion of FIG. 1;

FIG. 2 is a front schematic view of an embodiment of the shield utilized in the connector of FIG. 1;

FIG. 2A is a side cross sectional view of the shield shown in FIG. 2;

FIG. 3 is a front schematic view of an embodiment of the shield optionally utilized in the connector of FIG. 1;

FIG. 3A is a side cross sectional view of the shield shown in FIG. 3;

FIG. 4 is a detail sectional view of an alternate embodiment of the invention wherein the shield is isolated from the post by means of an insulative member;

FIG. 5 is a detail sectional view of an alternate embodiment of the invention wherein the shield is isolated from the post by means of fitment with the body; and

FIGS. 6 through 6D are front schematic views of embodiments of the shield; and

FIG. 7 is a cross sectional view of the coaxial connector of FIG. 1 with a coaxial cable disposed therein.

### DETAILED DESCRIPTION OF THE DRAWINGS

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Coaxial cable connectors are used to couple a prepared end of a coaxial cable to a threaded female equipment connection port of an appliance. The coaxial cable connector may have a post or may be postless. In both cases though, in addition to providing an electrical and mechanical connection between the conductor of the coaxial connector and the conductor of the female equipment connection port, the coaxial cable connector provides a ground path from the braided sheath of the coaxial cable to the equipment connection port. Maintaining a stable ground path protects against the ingress of undesired radio frequency (“RF”) signals which may degrade performance of the appliance. This is especially applicable when the coaxial cable connector is loosened from the equipment connection port, either due to not being tightened upon initial installation or due to becoming loose after installation.

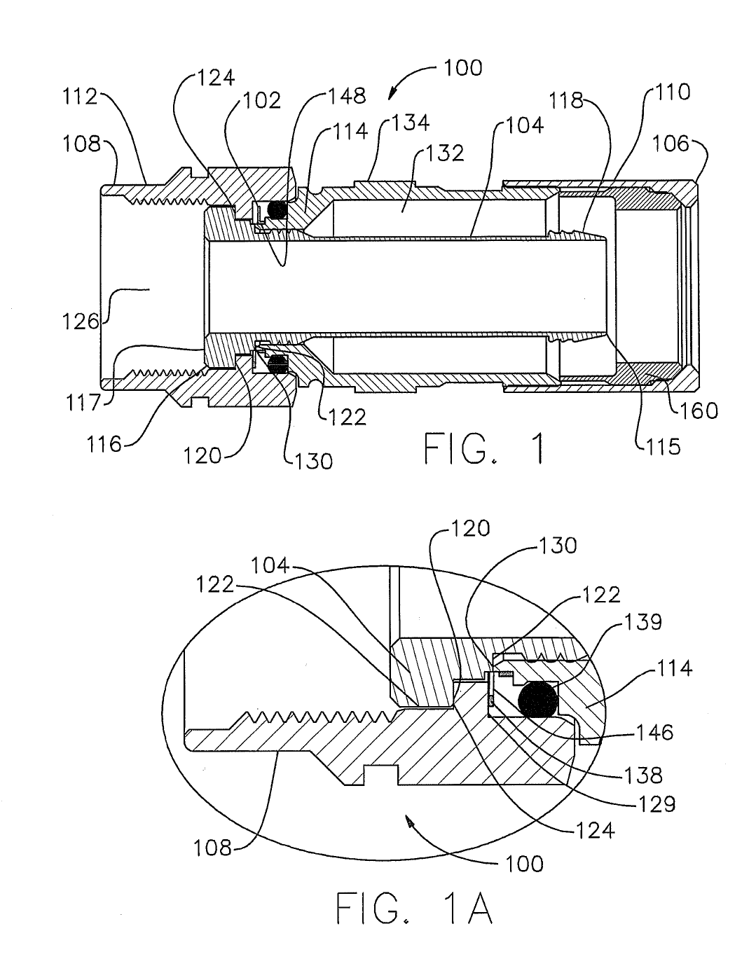

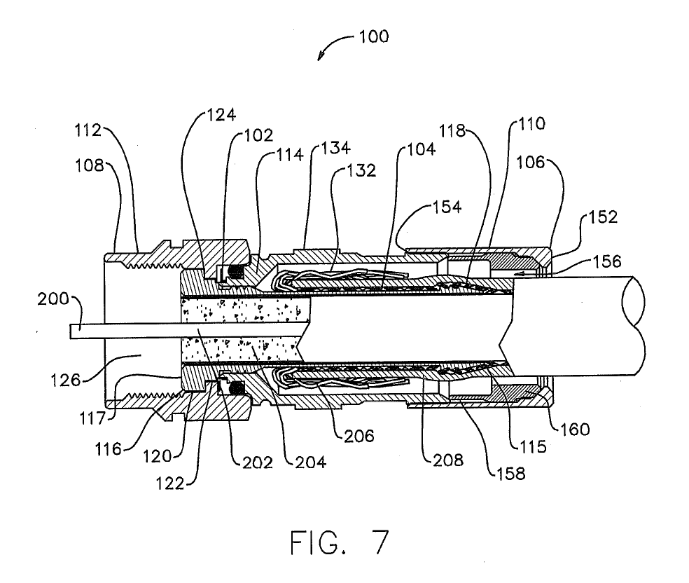

In this regard, FIGS. 1 and 1A illustrate an exemplary embodiment of coaxial cable connector 100 having a shield 102 to provide a stable ground path and protect against the ingress of RF signals. The coaxial cable connector 100 is shown in its unattached state, without a coaxial cable inserted therein. The coaxial cable connector 100 couples a prepared end of a coaxial cable to a threaded female equipment connection port (not shown in FIG. 1). This will be discussed in more detail with reference to FIG. 7. The coaxial cable connector 100 has a first end 106 and a second end 108. A shell 110 slidably attaches to the coaxial cable connector at the first end 106. A coupler 112 attaches to the coaxial cable connector 100 at the second end 108. The coupler 112 may rotatably attach to the second end 108, and, thereby, also to the tubular post 104. The shield 102 is disposed about the body 114 of the coaxial connector 100. In this way, the shield 102 provides an electrically conductive path between the body 114, and the coupler 112. The shield 102 is prevented from contacting the post by means of a clearance fit between the post features and the shield features. This enables an electrically conductive path from the coaxial cable through the coaxial cable connector 100 to the equipment connection port providing shielding against RF ingress and grounding.

Continuing with reference to FIGS. 1 and 1A, the tubular post 104 has a first end 115 which is adapted to extend into a coaxial cable and a second end 117. An enlarged shoulder 116 at the second end 117 extends inside the coupler 112. At the first end 115, the tubular post 104 has a circular barb 118 extending radially outwardly from the tubular post 104. The enlarged shoulder 116 comprises a first rearward facing annular shoulder 120, and a stepped diameter leading to a second rearward facing annular shoulder 122. The coupler 112 comprises a forward facing annular surface 124, a through-bore 126 and a rearward facing annular surface 129. The body 114 at least partially comprises a face 130, a through bore 132 and an external annular surface 134. An inner surface 148 of the shield 102 is disposed about the body 114 proximate to end 108. In this manner, the shield 102 is secured within the coaxial cable connector 100, and establishes an electrically conductive path between the body 114 and the coupler 112. Further, the shield 102 remains secured independent of the tightness of the coaxial cable connector 100 on the appliance equipment connection port. In other words, the shield 102 remains secured and the electrically conductive path remains established between the body 114 and the coupler 112 even when the coaxial cable connector is loosened and/or disconnected from the appliance equipment connection port. Additionally, the shield 102 has resilient and flexible cantilevered annular beams 138 disposed against the rearward facing annular surface 128 of the coupler 112. In this manner, the cantilevered annular beams 138 maintain contact with the coupler independent of tightness of the coaxial cable connector 100 on the appliance equipment connection port without restricting the movement, including the rotation of the coupler 112. The coaxial cable connector 100 may also include a sealing ring 139 seated within the coupler 112 to form a seal between the coupler 112 and the body 114.

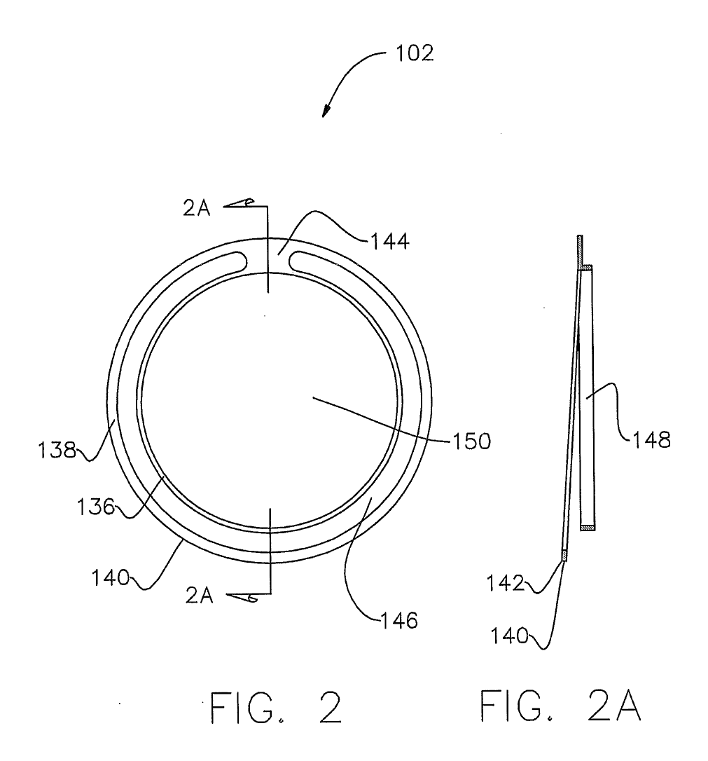

Referring now to FIGS. 2 and 2A, the shield 102 may be circular with the inner segment 136 and at least one pre-formed cantilevered annular beam 138. The at least one pre-formed cantilevered annular beam 138 is flexible, arcuately shaped and extends at approximately a 19° angle from the plane of the inner segment 136. The pre-formed cantilevered annular beam 138 has an outer surface 140 with an edge 142, as shown in FIG. 2A. Joining segment 144 joins the pre-formed cantilevered annular beam 138 to the inner segment 136 forming a slot 146 therebetween. The inner segment 136 has an inner surface 148 that defines a central aperture 150. The shield 102 may be made from a metallic material, including as a non-limiting example, phosphor bronze, and have a width of approximately 0.005 inches. Additionally or alternatively, the shield 102 may be un-plated or plated with a conductive material, as non-limiting examples tin, tin-nickel or the like

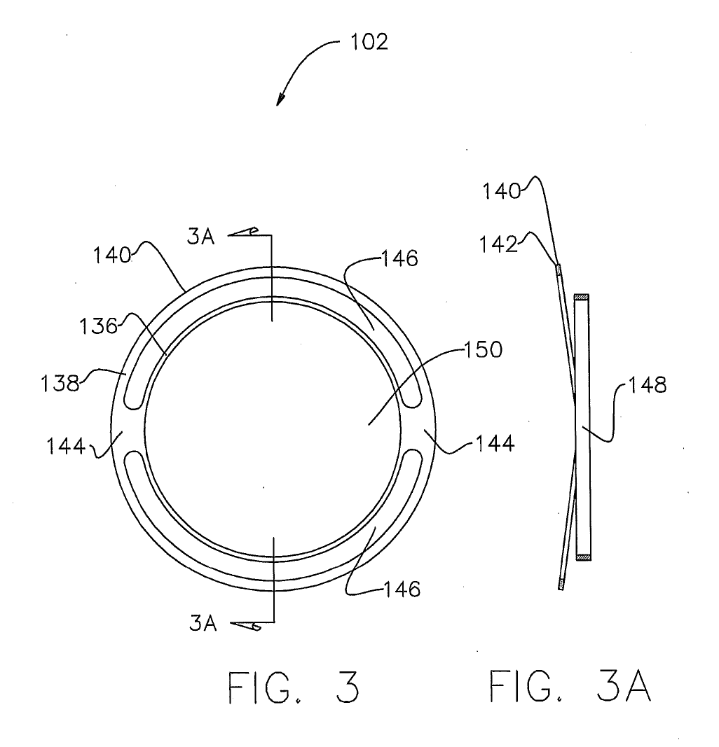

Referring now to FIGS. 3 and 3A, the shield 102 may be circular with the inner segment 136 and may have a plurality of pre-formed cantilevered annular beams 138. The pre-formed cantilevered annular beams 138 are flexible, arcuately shaped and extend at approximately a 19° angle from the plane of the inner segment 136. The pre-formed cantilevered annular beams 138 have an outer surface 140 with an edge 142, as shown in FIG. 3A. Joining segments 144 join the plurality of the pre-formed cantilevered annular beams 138 to the inner segment 136 forming a plurality of slots 146 therebetween. The inner segment 136 has an inner surface 148 that defines a central aperture 150. Shield 102 may be made from a metallic material, including as a non-limiting example, phosphor bronze, and have a width of approximately 0.005 inches. Additionally or alternatively, the shield 102 may be un-plated or plated with a conductive material, as non-limiting examples tin, tin-nickel or the like

Pre-forming the cantilevered annular beams 138 as illustrated in FIGS. 2A and 3A, provides improved application of the material properties of the shield 102 to provide a spring force biasing the edge 142 toward the rearward facing annular surface 129 and causing the edge 142 of outer surface 140 to intimately contact rearward facing annular surface 129 of the coupler 112. Because of this, the shield 102 may be manufactured without having to utilize a more expensive material such as beryllium copper. Additionally, the material of the shield 102 does not need to be heat treated. Further, the natural spring-like qualities of the selected material are utilized, with the modulus of elasticity preventing the shield 102 from being over-stressed by providing for limited relative axial movement between coupler 112, the tubular post 104 and the body 114

Electrical grounding properties are enhanced by providing an arcuately increased area of surface engagement between the edges 142 of the cantilevered annular beams 138 and rearward facing annular surface 129 of coupler 112 as compared, for example, to the amount of surface engagement of individual, limited number of contact points, such as raised bumps and the like. In this manner, the increased area of surface engagement provides the opportunity to engage a greater number of Asperity spots (“A-spots”) rather than relying on the limited number of mechanical and A-spot points of engagement. Additionally, the edge 142 may have a knife-like sharpness. Thus, the knife-like sharpness of the edge 142 makes mechanical contact between the cantilevered annular beams 138 and rearward facing annular surface 129 of coupler 112 without restricting the movement of the coupler 112. Also, the knife-like sharpness of the edge 142 and the plating of shield 102 provide a wiping action of surface oxides to provide for conductivity during periods of relative motion between the components.

Moreover, in addition to the increased number of A-spot engagement, the increased area of surface engagement results in an increased area of concentrated, mechanical pressure. While providing the degree of surface contact and concentrated mechanical force, the shield 102 does not negatively impact the “feel” of coupler rotation due to the limited amount of frictional drag exerted by the profile of edges 142 against reward facing annular surface 128.

The shield 102 is resilient relative to the longitudinal axis of the coaxial cable connector 100 and maintains an arcuately increased surface of sliding electrical contact between shield 102 and the rearward facing annular surface 129 of the coupler 112. At the same time the shield is firmly mounted and grounded to the body 114 providing assured electrical and mechanical communication between the coupler 106, the body 114 while allowing smooth and easy rotation of the coupler 112.

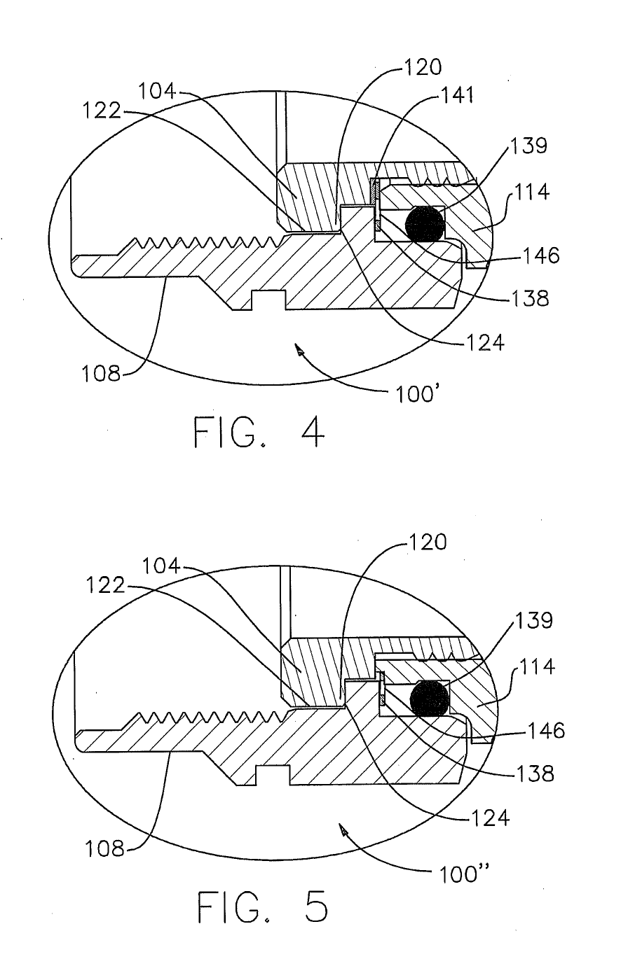

Referring now to FIG. 4, there is shown a detail view of the shield 102 disposed in another coaxial cable connector 100′. In FIG. 4 the shield 102 is in contact with the body 114 but isolated from the post 104 by an insulative member 139 that is interposed between the post 104 and the shield 102.

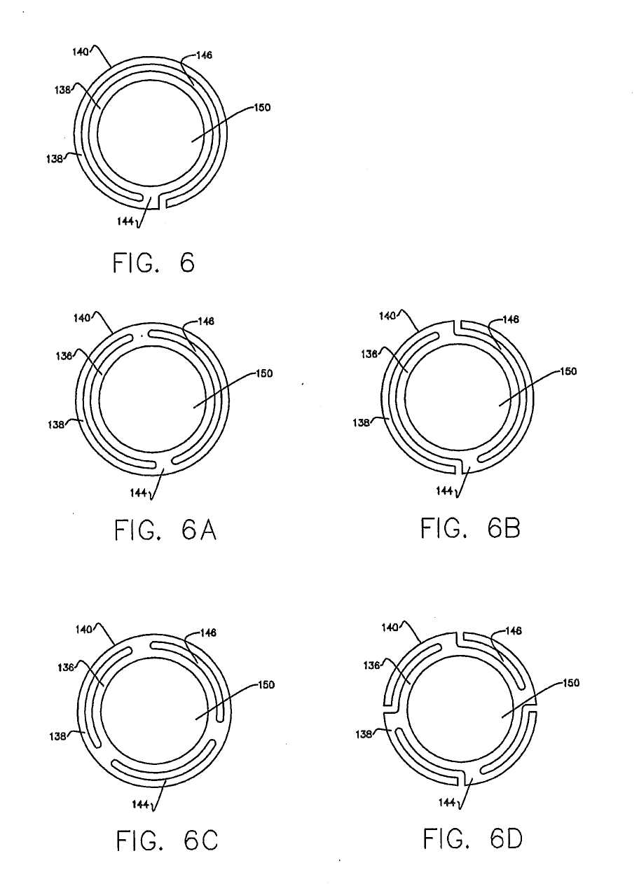

Referring now to FIG. 5, there is shown a detail view of the shield 102 disposed in another coaxial cable connector 100″. In FIG. 5 the shield 102 is in intimate contact with the body 114 but isolated from the post 104 by the physical step configuration of the body 114.

FIGS. 6 through 6D illustrate optional embodiments of the shield 102 with differing patterns of slots 146, cantilevered annular beams 138, and the joining segments 144. Slots 146 may break through one side of the cantilevered beams 138 forming a single ended cantilevered beam or, alternatively, may not break out through one side of the cantilevered beam forming a double ended cantilevered beam. Endless variations and patterns may be achieved.

Referring now to FIG. 7, the coaxial cable connector 100 is shown with a coaxial cable 200 inserted therein. The shell 106 has a first end 152 and an opposing second end 154. The shell 106 may be made of metal. A central passageway 156 extends through the shell 106 between first end 152 and the second end 154. The central passageway 156 has an inner wall 158 with a diameter commensurate with the outer diameter of the external annular surface 134 of the body 112 for allowing the second end 154 of the shell 106 to extend over the body 112. A gripping ring or member 160 (hereinafter referred to as “gripping member”) is disposed within the central passageway 156 of the shell 106. The central passageway 156 proximate the first end 152 of shell 106 has an inner diameter that is less than the diameter of the inner wall 158.

The coaxial cable 200 has center conductor 202. The center conductor 202 is surrounded by a dielectric material 204, and the dielectric material 204 is surrounded by an outer conductor 206 that may be in the form of a conductive foil and/or braided sheath. The outer conductor 206 is usually surrounded by a plastic cable jacket 208 that electrically insulates, and mechanically protects, the outer conductor. A prepared end of the coaxial cable 200 is inserted into the first end 106 of the coaxial cable connector 100. The coaxial cable 200 is fed into the coaxial cable connector 100 such that the circular barb 118 of the tubular post 104 inserts between the dielectric material 204 and the outer conductor 206 of the coaxial cable 200, making contact with the outer conductor 206. A tool (not shown) advances the shell 106 toward the coupler 112. As the shell 106 is advanced over the external annular surface 134 of the body 114 toward the coupler 112, the reduced diameter of the central passageway 156 forces the gripping member 160 against the cable jacket 208. In this manner, the coaxial cable 200 is retained in the coaxial cable connector 100. Additionally, the circular barb 118 positioned between the dielectric material 204 and the outer conductor 206 acts to maximize the retention strength of the cable jacket 202 within coaxial cable connector 100. As the shell 106 moves toward the second end of the coaxial cable connector 100, the shell 106 forces the gripper member 160 between the body 114 and the cable jacket 202. In this manner, the cable jacket 202 is captured between the gripper member 160 and the circular barb 118 increasing the pull-out force required to dislodge cable 200 from coaxial cable connector 100. Since the outer conductor 206 is in contact with the tubular post 104 an electrically conductive path is established from the outer conductor 206 through the tubular post 104 to the body 114 to the shield 102 and, thereby, to the coupler 112.

Further, the shield 102 secured within the connector 100 and the electrically-conductive path remains established independent of the tightness of the coaxial cable connector 100 on the appliance equipment connection port. In other words, the shield 102 remains secured and the electrically conductive path remains established between the body 114 and coupler 112 even when the coaxial cable connector is loosened and/or disconnected from the appliance equipment connection port. Additionally, the shield 102 has resilient and flexible cantilevered annular beams 138 disposed against the rearward facing annular surface 129 of the coupler 112. In this manner, the cantilevered annular beams 138 maintain contact with the coupler independent of tightness of the coaxial cable connector 100 on the appliance equipment connection port without restricting the movement, including the rotation of the coupler 112.

It will be apparent to those skilled in the art that various modifications and variations can be made to the embodiments discussed above. Additionally, the embodiments of the shield 102 may be used with other types of coaxial cable connector shield including without limitation, compression, compression-less and post-less coaxial cable connectors. Thus, it is intended that this description cover the modifications and variations of the embodiments and their applications.

What is claimed is:

1. An RFI and grounding shield for a coaxial cable connector having a coupler and a body, the shield, comprising:
an inner segment, wherein the inner segment is configured to contact the body of the connector;
at least one pre-formed cantilevered annular beam attached to the inner segment and angularly extending from a plane of the inner segment, wherein the at least one pre-formed cantilevered annular beam is configured to apply a spring-force to a surface of the coupler establishing an electrically conductive path between body and the coupler coaxial cable connector when the shield is positioned in the coaxial cable connector.

2. The shield of claim 1, wherein the inner segment is configured to friction fit to the connector body.

3. The shield of claim 1, wherein the inner segment is generally circular.

4. The shield of claim 1, wherein the inner segment has an inner surface that defines an aperture.

5. The shield of claim 4, wherein the body fits inside the aperture.

6. The shield of claim 1, wherein the at least one pre-formed cantilevered annular beam is arcuately shaped.

7. The shield of claim 1, wherein the at least one pre-formed cantilevered annular beam comprises an outer surface with an edge, and wherein the edge has a knife-like sharpness and provides a wiping action of surface oxides on the coupler of the coaxial cable connector.

8. The shield of claim 1, wherein the inner segment and the at least one pre-formed cantilevered annular beam are metallic.

9. The shield of claim 8, wherein the inner segment and the at least one pre-formed cantilevered annular beam are formed of phosphor bronze.

10. The shield of claim 1, further comprising a conductive material plating.

11. The shield of claim 10, wherein the conductive material plating is one of tin and tin-nickel.

12. The shield of claim 1, wherein the at least one pre-formed cantilevered annular beam comprises a plurality of pre-formed cantilevered annular beams.

13. The shield of claim 1, wherein the inner segment is disposed proximate the body but is isolated from the post.

14. A coaxial cable connector for coupling a coaxial cable to an equipment port, the coaxial cable including a center conductor surrounded by a dielectric material, the dielectric material being surrounded by an outer conductor, the coaxial cable connector comprising:
a tubular post having a first end adapted to be inserted into the prepared end of the coaxial cable between the dielectric material and the outer conductor, and having a second end opposite the first end thereof;
a coupler having a first end rotatably secured over the second end of the tubular post, and having an opposing second end, the coupler including a central bore extending therethrough, a portion of the central bore proximate the second end of the coupler being adapted for engaging the equipment port;
a body secured to the tubular post and extending about the first end of the tubular post for receiving the outer conductor of the coaxial cable, wherein the body member contacts the shield; a resilient, electrically-conductive shield having an inner segment and at least one pre-formed cantilevered annular beam attached to the inner segment, wherein the inner segment is disposed proximate the body, and the at least one pre-formed cantilevered annular beam exerts a spring-like force on the coupler, and wherein the shield provides an electrically-conductive path between the body and the coupler, and wherein the shield remains captured and secured and provides the electrically-conductive path independent of the tightness of the coaxial cable connector.

15. The coaxial cable connector of claim 14, wherein the shield is generally circular and the at least one pre-formed cantilevered annular beam is arcuately shaped.

16. The coaxial cable connector of claim 14, wherein the second end of the tubular post has an enlarged shoulder comprising a first rearward facing annular shoulder and a second rearward facing annular shoulder.

17. The coaxial cable connector of claim 14, wherein the coupler comprises a rearward facing annular surface, and wherein the at least one pre-formed cantilevered annular beam exerts a spring-like force on the coupler at the rearward facing annular surface.

18. The coaxial cable connector of claim 14, wherein the shield is resilient relative to the longitudinal axis of the connector and maintains an arcuately increased surface of sliding electrical contact between the shield and the rearward facing annular surface of the coupler.

19. The coaxial cable connector of claim 14, wherein the at least one pre-formed cantilevered annular beam comprises an outer surface with an edge, and wherein the edge has a knife-like sharpness and provides a wiping action of surface oxides on a surface of the coupler.

20. The coaxial cable connector of claim 14, wherein the shield provides for unrestricted rotation of the coupler.

21. The coaxial cable connector of claim 14, wherein the shield maintains the electrically conductive path between the coaxial cable conductor and an equipment connection port of an appliance when the coupler is loosened from while in contact with the equipment connection port.
